(19) United States
(12) Patent Application Publication
(10) Pub. No.: US 2008/0156273 A1
(43) Pub. Date: Jul. 3, 2008

(54) Bridcage catchall with protector panels pet accessories

(76) Inventors: Linda LoCascio, Clearwater, FL (US); Joseph LoCascio, Allendale, NJ (US)

Correspondence Address: Linda LoCascio, # 604, 1390 Gulf Blvd., Clearwater, FL, 33767, US

(21) Appl. No.: 12/001,448

(22) Filed: Dec. 11, 2007

Related U.S. Application Data
(60) Provisional application No. 60/878,249, filed on Jan. 3, 2007.
(60) Provisional application No. 60/932,693, filed on Jun. 2, 2007.

(51) Int. Cl. A01K 31/06

(52) U.S. Cl. 119/469

(57) ABSTRACT

The Birdcage Catchall and the Protector Panels are pet accessories and are used to catch seed, feathers and debris that falls from the birdcages. The catchall is suspended under the cage and forms a barrier around and under the cage to catch debris. The Protector Panels, when used with the catchall aid in additional cleanliness and also insure protection from drafts and sunlight. Both elements are made of printed washable fabric and are hung onto the cage with metal hooks.

Cross Reference filed from earlier provisional applications:

Birdcage Catchall

Application # U.S. 60/878,249

Filed: Jan 24, 2007

Protector Panels

Application # U.S. 60/932,693

Filed: Jun. 28, 2007

Birdcage Catchall with Draft Protector Panels

Non Provisional Patent Application Ser. No. 12/001,448

Filed: Dec. 11, 2007

### BACKGROUND OF INVENTION

This is a pet product specifically designed for birdcages. The Birdcage Catchall with the Protector Panels address problems in keeping the birdcage and surrounding area clean from debris and protect birds from drafts and sunlight.

This type of protection is more effective than other cage catchers on the market because it forms a large open barrier around the cage and offers draft and light protection for the bird as well.

### SUMMARY OF THE INVENTION

The advantage of the Birdcage Catchall and the Protector Panels is to keep the area under and around the cage sanitary and free from falling debris. When the Protector Panels are hooked onto the sides of the cage in conjunction with the Birdcage Catchall a more closed barrier is formed for more assured cleanliness.

The Birdcage Catchall can be folded into a pouch to hold the debris in place when cleaning it. This eliminates flying feathers & debris when transporting it for disposal.

### DETAILED DESCRIPTION

These are pet accessories for birds.

The Birdcage Catchall is made of light weight printed fabric, washable fabric. It forms a basket-like open barrier, under, around and on the sides of the cage and is suspended under the cage with the use of loops and hooks. It measures 24″ W×24″ L and is 7″ deep. Half inch casings are sewn along the top perimeter. Buttonholes are sewn into the casings and ¼″ dowels are inserted into the casings through the buttonholes. This holds the catcher open and gives it stability. Three loops are sewn into each corner to hold the 8″ metal hooks that hold the catchall to the cage.

The Birdcage Catchall has a unique cleaning feature. After it is removed from the cage for cleaning, it folds into a pouch. This feature traps the debris inside the pouch making it easy to dispose of the contents without releasing accumulated debris. The Protector Panels measure 24″ W×16″ L. They are made of the same fabric as the Birdcage Catchall and have a ¾″ casing at the top that holds a ¼″ wooden dowel. Two loops are sewn 1″ from the sides of the panel and small 1″ hooks are inserted into the loops to attach the panel to the cage.

When the Protector Panels are used with the Birdcage Catchall additional protection is insured against falling debris and also protects the bird from drafts and sunlight.

### DRAWINGS

FIG. 1.

Shows a square basket-like fabric open barrier tray 24″ W×24″ L with ¾″ casings sewn along the top perimeter.

Three fabric loops are at each corner and at 6″ on either side of the corner. This repeats at each corner.

FIG. 2.

Shows view if one corner of the catcher with a ⅜″ buttonhole placed on the inside and at the end of the casing. A ¼″ wooden dowel is inserted into the casing through the buttonhole.

This repeats at each corner.

FIG. 3.

Shows one corner of Birdcage Catchall with a metal hook inserted into the center loop. Each hook is 8″ L×1″ W. This repeats at each corner.

FIG. 4.

Shows the Protector Panel as it is made with a 1″ hem sewn on 3 sides and a ¾″ casing sewn across the top. A ¼″ wooden dowel is inserted into the casing. Two fabric loops are sewn to the top of the casing 1″ from either end of the panel.

Small 1″ metal hooks are inserted into the loops to attach the panel to the cage.

Each panel measures 24″ W×18″ L

FIG. 5.

Shows the Birdcage Catchall hung onto a birdcage.

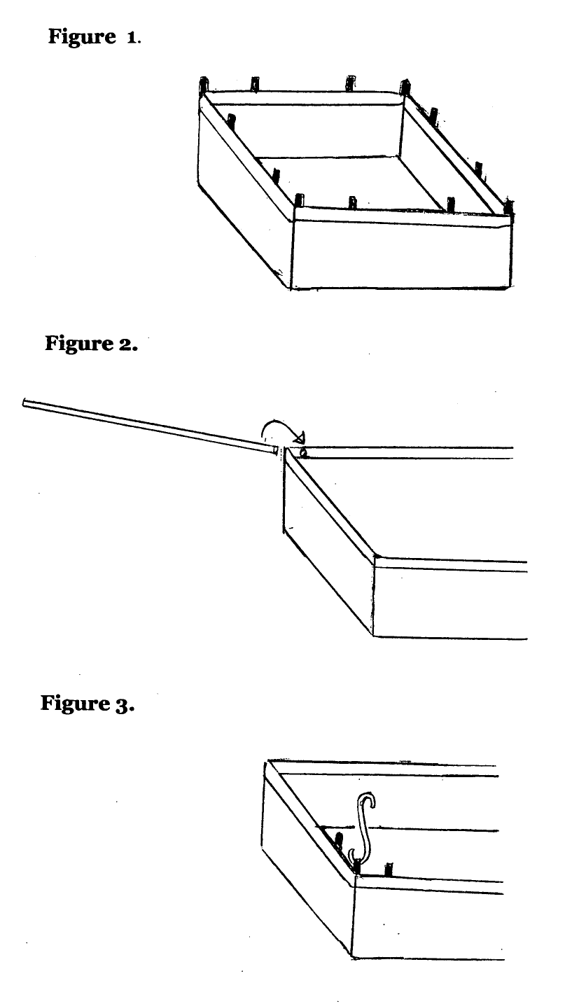

FIG. 1.

Remove catcher from cage with debris caught in catcher.

FIG. 2.

Fold catcher from A. To B.

FIG. 3.

Fold catcher again from C. to D.

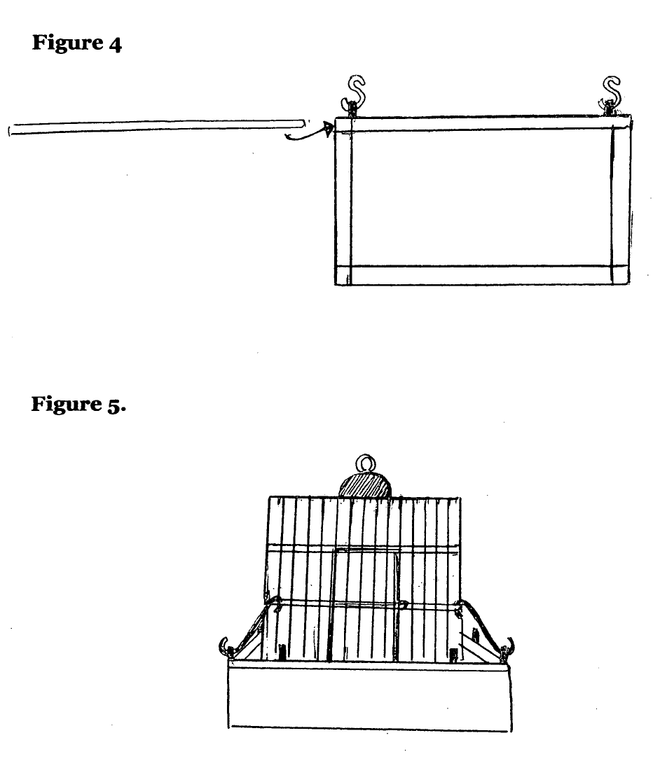

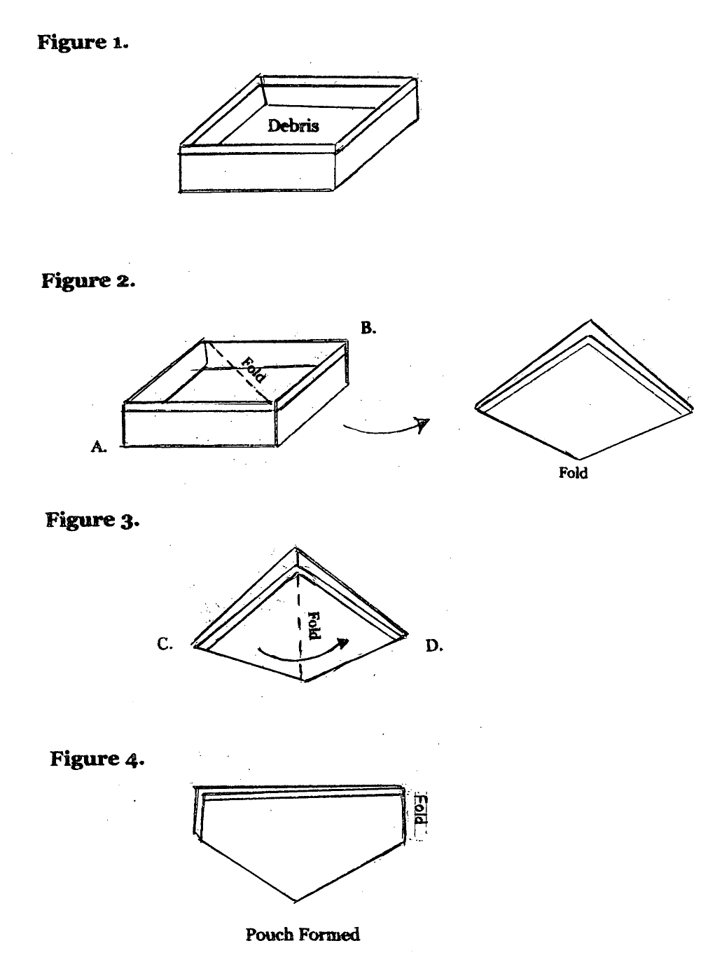

FIG. 4.

Shows pouch is now formed to enclose debris and easily and cleanly discard contents.

What is claimed as being new and desired to be protected by Letters Patent of the U.S. is as follows:

1. New pet accessory for birdcages to keep birdcage area clean and sanitary.
a. Forms an basket-like open barrier under and around the cage to catch debris.

2. Made of attractive printed light weight washable fabric.
a. Makes cleaning and emptying easy by folding into a pouch to trap accumulated debris for disposal.

3. Additional Protector Panels
a. Panels add the protection from sunlight and drafts to which birds are sensitive and add more protection against falling debris when used with the catchall.
